(19) United States
(12) Patent Application Publication
(10) Pub. No.: US 2003/0018551 A1
(43) Pub. Date: Jan. 23, 2003

(54) Method of hosting digital businesses

(75) Inventors: James E. Hanson, Yorktown Heights, NY (US); Steve R. White, New York, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/911,016

(22) Filed: Jul. 20, 2001

(51) Int. Cl. G06F 17/60

(52) U.S. Cl. 705/35; 705/30; 705/39

(57) ABSTRACT

A method, system, and computer program product for providing electronic business functions for a business client is provided. In one embodiment, a host provides, on a data processing system, first level and second level services for several business clients. The first level services may include such features as storage, network connectivity, web hosting, and processing power. The second level services may include software designed to meet the specific needs of the business clients and may include such functionality as accounting services, inventory management services, price determination services, product and service ordering services, and negotiating services. The host may facilitate transactions between one business client and another business client on behalf of the clients by identifying needs of one business client and identifying the capability of another business client to fulfill those needs. The host automatically completes the electronic portions of the transaction including ordering the item, updating inventory records, completing payment for the item (including updating accounting records), and arranging for and monitoring shipping, if necessary.

### BACKGROUND OF THE INVENTION

1. Technical Field

The present invention relates generally to computer software and, more particularly, to methods and systems for hosting digital components of businesses.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach.

Often businesses utilize a third party host to provide some or all of the resources necessary to have an Internet presence for their business (e.g., e-Hosting). As the Internet has continued to grow, e-Hosting has developed into a way in which an online business might provide, for a fee, a computational components/services such as bandwidth, storage, and computational power (CPU) to client businesses. Typically, these schemes restrict themselves to low-level services. Furthermore, they have relied on manual setup.

Related to this, though at a more sophisticated level, are Application Service Providers (ASPs), which sell clients access to application programs (such as spreadsheets, Web storefronts, etc.). ASPs are in the “software rental” business. Typically, the applications they provide are intended for human users, and typically, again, the host-client relationship is manually set up, monitored, and maintained.

However, none of these services meets the needs of so-called “digital businesses”. In a digital business, much or all of the firm's day-to-day activity are partially or fully automated. Digital businesses may also automate tactical decision-making processes such as setting prices on products, negotiating trades, etc. Clearly, other parts of digital businesses, such as, for example, manufacturing, advertising, may also be partially or fully automated. With the continuing trend in e-business automation, digital businesses are fast becoming a reality. Therefore, there is an emerging need for a hosting service tailored specifically for the needs of digital businesses.

### SUMMARY OF THE INVENTION

The present invention provides a method, system, and computer program product for providing electronic business functions for a business client. In one embodiment, a host provides, on a data processing system, first level and second level services for several business clients. The first level services may include such features as storage, network connectivity, web hosting, and processing power. The second level services may include software designed to meet the specific needs of the business clients and may include such functionality as accounting services, inventory management services, price determination services, product and service ordering services, and negotiating services. The host may facilitate transactions between one business client and another business client on behalf of the clients by identifying needs of one business client and identifying the capability of another business client to fulfill those needs. The host automatically completes the electronic portions of the transaction including ordering the item, updating inventory records, completing payment for the item (including updating accounting records), and arranging for and monitoring shipping, if necessary.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a block diagram illustrating an exemplary digital business hosting system in accordance with the present invention;

FIG. 5 depicts a block diagram illustrating an exemplary e-business facility in accordance with the present invention;

FIG. 6 depicts an exemplary process flow and program function for facilitating a business transaction between two business clients of a digital business host in accordance with the present invention;

FIG. 7 depicts an exemplary process flow and program function for providing a customer ordering service to a e-business client via a digital business host in accordance with the present invention;

FIG. 8 depicts an exemplary process flow and program function for setting prices for a e-business client's products in accordance with the present invention;

FIG. 9 depicts an exemplary process flow and program function for managing a client's inventory in accordance with the present invention; and

FIG. 10 depicts a block diagram providing an illustrative example of how the host would preferably support fast, automated reconfiguration of the services “leased” to a client business in accordance with the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also maybe implemented as a number of different types of networks, such as for example, an intranet, a local area network (LAN), or a wide area network (WAN). FIG. 1 is intended as an example, and not as an architectural limitation for the present invention.

While the present invention may be implemented in a distributed data processing system such as that shown in FIG. 1, the present invention is not limited to any particular distributed data processing system architecture. Rather, the present invention may be implemented in any distributed data processing system without departing from the spirit and scope of the present invention. For example, rather than a server/client architecture, such as that shown in FIG. 1, the present invention may be implemented in a peer-to-peer distributed data processing system in which client computers communicate and interact with one another directly without requiring a server computing device to facilitate such interaction.

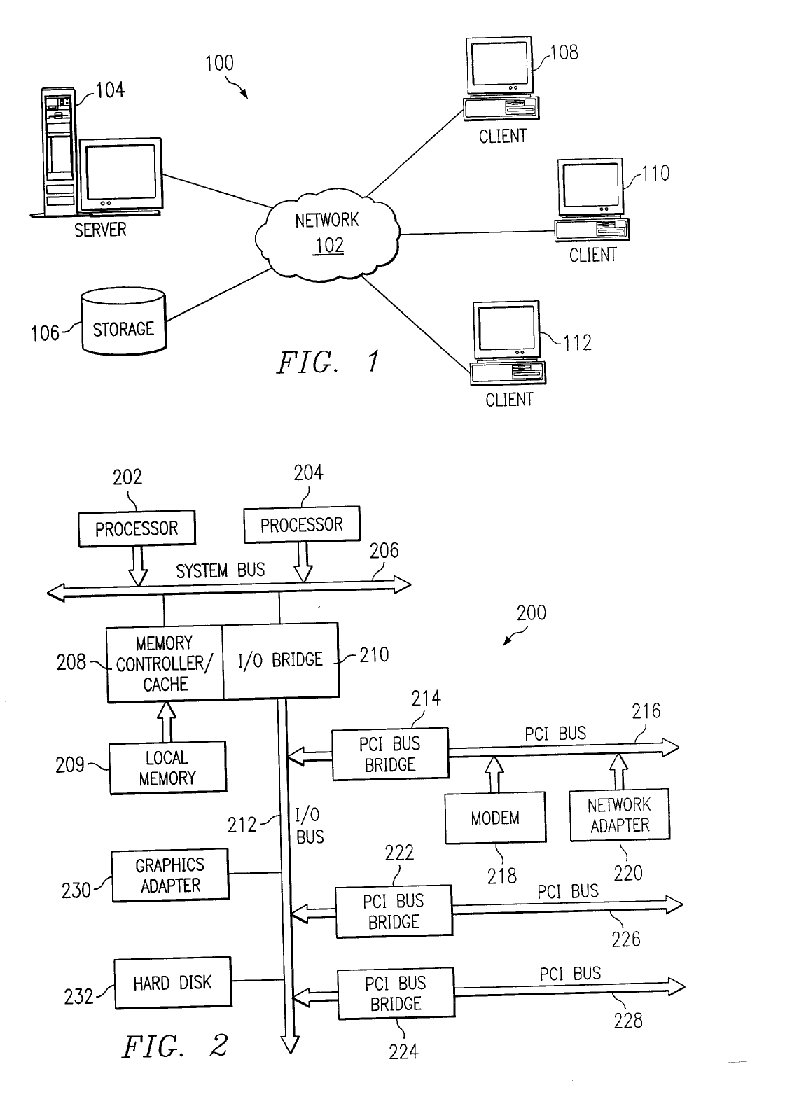

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

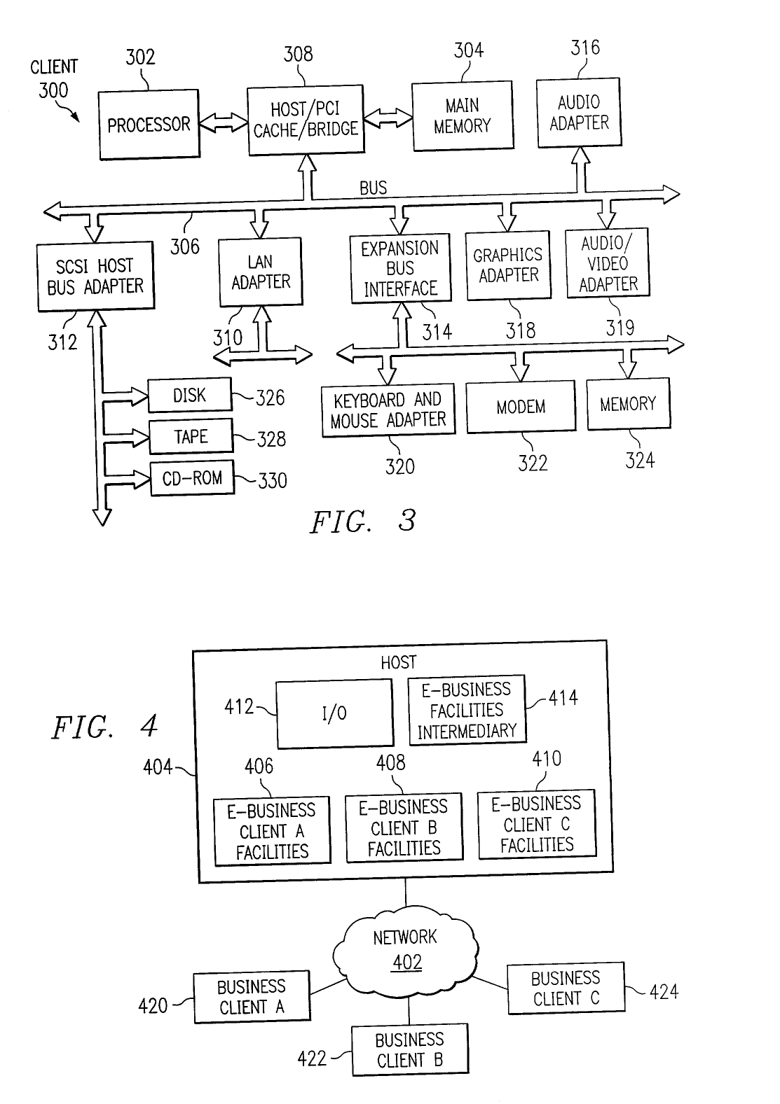

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference now to FIG. 4, a block diagram illustrating an exemplary digital business hosting system is depicted in accordance with the present invention. The hosting system includes a host 404, a network 402, and business clients A 420, B 422, and C 424. Host 404 may be implemented on one or several data processing systems, such as, server 200 in FIG. 2. Business clients A 420, B, 422, and C 424 may be implemented as, for example, either server 200 in FIG. 2 or client 300 in FIG. 3.

Network 402 may be implemented as, for example, network 102 in FIG. 1. i 15 Host 404 provides the digital portions of the businesses for business clients 420-424. Host 404 may provide some or all of the digital business aspects of each of business clients 420-424 served by host 404. In a preferred embodiment, host 404 includes the following digital components:

1. Low-level services (“e-Utilities”) provided by the host 404;

2. High-level services or components provided by the host 404;

3. Client-supplied high-level components; and optionally

4. Native peer services 414 provided by the host 404.

Low-level services, which may be included in e-business client facilities 406-410, are provided by the host 404 for use by client businesses 420-424. A client business 420-424 negotiates for the amount of each utility; on the side of the host 404. This negotiation is preferably automated. Preferably, as the client's 420-424 needs change, it could change the amount of these services that it uses, renegotiate the terms, etc. Examples of these services include storage, CPU, and network connectivity.

The host 404 may optionally outsource, either by subcontracting or leasing the services or buying the services outright, some or all of the low-level services to an ordinary e-Hosting or e-Utility service. In this case, the host 404 serves as a provider of high-level services and/or native peer services, which use low-level services provided by the other low-level service provider in the usual fashion.

High-level services or components, which may be included in e-business client facilities 406-410, provided by the host 404 are software components, modules, or services that are designed to meet the specific needs of digital businesses. They are designed and maintained by the host 404. A client business 420-424 leases an instance of one, or the use of one. Clients 420-424 customize these services to suit their particular needs. Payment could be per-use, etc. As the client's 420-424 needs changed, it may change the selection of high-level components that it uses.

Necessarily, these high-level components would be able to operate in the host's environment. Preferably, they would be crafted to interoperate well with each other. Thus, one client 420 might use one component to transact business with another client 422 using a different component. For such a thing to happen, the two components must interoperate.

The host would preferably also provide means for interoperating with businesses that are hosted by other entities, or that are not hosted. These could take the form of low-level services for connecting to other hosts or business clients on the Internet; or high-level services for translating between the foreign host's or client's messaging protocols, interfaces, or the like, and those of the present host; or native peer services that perform the analogous activities for hire.

A client 420-424 may automatically or manually set strategic parameters & variables that would modify, govern, or constrain the behavior of the digital components or e-business client facilities 406-410 being provided by the host 404. In the case of manual configuration, the component would provide information to the client firm's 420-424 operators (e.g., by a Web interface) and receive modifications from the operators. In the case of automatic configuration, the component would receive configuration information using any standard communication interface (e.g., XML over SOAP).

Examples of high level services include support for protocols for negotiation, payment or other communication, and ontology support. Other examples may include suites of automated negotiation strategies, bundling strategies, price-setting strategies, strategies for other things. A payment system is a natural component to provide, especially one that interoperates with the payment system used by the hosting service itself to collect from clients. A Universal Description, Discovery, and Integration of business on the web (UDDI) server may also be one of the high-level components available. (For more information about UDDI, see www.uddi.org.) The high-level components may include accounting, inventory management, order tracking, customer-relationship management, etc., software as well. Optionally, the high-level components would include subsystems that monitored the clients' use for billing & payment purposes.

Client-supplied high-level components may include software supplied by the client 420-424 that runs in the environment created by the host 404. Client 420-424-supplied software could make use of the total environment provided by the host 404.

Both host-provided and client-supplied high-level components would preferably be able to take on the role of clients themselves, calling upon other services on the host (whether low-level, high-level, or native peer) as they required, according to terms set by the client business.

Native peer services 414 that are optionally provided by the host 404 may include specific services that themselves appear as digital businesses—e.g., “middle agents”. These would be available for hire by client businesses 420-424, and especially by the digital components or e-business client facilities 406-410 operated by the hosting service. One advantage of this sort of setup is that a client business 420-424 may interact with the middle agents using the same software modules for communication, negotiation, decision-making, etc., that it uses for interacting with other digital firms. The host 404 might deploy as many or as few native peer services as it sees fit, to maximize its total revenue. It may offer these services free of charge, or partially subsidize them, or let them alone. They might set fees, etc., to maximize their own profit. Examples of native peer services include directory service agents that maintain registries of firms and contact information, matchmaker agents that assist firms that need a particular service in finding other firms that provide it, and brokers of various types.

For an example of how a matchmaker agent might operate, see commonly assigned U.S. patent application Ser. No. 09/821,281 entitled “Seamless, Autonomous Introduction of New Goods and Services into a Dynamic Information Economy”, filed on Mar. 29, 2001, which describes a matchmaker agent operating as a free-lance business in an economy of digital businesses. The contents of commonly assigned U.S. patent application Ser. No. 09/821,281 is hereby incorporated herein by reference for all purposes. A matchmaker operated by a hosting service, such as, for example, host 404, could operate in a closely equivalent manner—with one crucial difference: in the current invention it is under the ultimate control of the host 404.

The host 404 transacts business with a client 420-424 in the same way any other digital business transacts business with the client 420-424. Thus, by virtue of being digital businesses, the clients 420-424 are equipped to negotiate for services and pay for them online. (In fact, the software used by the clients 420-424 for certain transactions may be supplied by the host 404 itself.)

Optionally, the client firm could establish an account with the host 404. This account could be set up online, possibly automatically, or it could be set up manually. It would preferably include a mechanism whereby the host 404 could receive payments from the client 420-424 in return for services rendered. But preferably it would not specify the components to be used by the client 420-424, how much they would be used, etc. Within the terms of that account, the client firm 420-424 would operate its business using digital components provided by the host 404 service. A client firm 420-424 need not run all of its digital components on the host 404; only the ones it chooses to. And a client 420-424 might well have accounts with multiple hosting services.

One currently preferred means of doing this is for the host to provide a high-level “account management” service that manages the client's account with the host. In that way, the account-management service acts as a “general contractor”, endowed by the client business with sufficient information to manage the client business's other hosted services.

The fees, terms & conditions of the provision of digital components to the client 420-424 are negotiated between the host 404 and client firm. Both sides of the negotiation are either partly or fully automated, and (presumably) have control parameters set by the owners of the respective firms. The negotiations may be as simple as posted pricing by the host 404, with acceptance or refusal by the client 420-424.

Compliance is monitored automatically, e.g., using electronic Service Level Agreements (eSLAs). An eSLA is a Service Level Agreement (SLA) that is expressed in a form that may be read or parsed by a computer. An SLA specifies the characteristics, terms, conditions, and other features of a service provided by one business to another business. SLAs typically contain items, such as, for example, specifications of the type of service to be provided, the quality level (e.g., reliability), the price or price schedule, means of payment, and remedies in case of failure. More information about eSLAs may be found in U.S. patent application Ser. No. 09/642,526 filed Aug. 18, 2000 entitled “Electronic Service Level Agreement for Web Site and Computer Services Hosting” assigned to the International Business Machines Corporation, the contents of which are hereby incorporated herein for all purposes.

Billing is automated and the client's 420-424 payment process may be automated as well. The host 404 charges the clients 420-424 in any of several ways. Clients 420-424 pay using any of several electronic payment schemes. Contracts may be negotiated automatically. But within a contract, leave certain things unspecified—again, via an SLA. These things are executed automatically by the host 404.

Host 404 may facilitate transactions between one of clients 420-424 and others of clients 420-424. However, host 404 may also facilitate transactions between one of clients 420-424 and businesses that are clients of other hosts are that are independent. Host 404 may facilitate transactions by handling client side aspects of negotiation, acceptance and completion based on parameters or other controls determined by the client.

FIG. 4 is intended as an example, and not as an architectural limitation for the present invention.

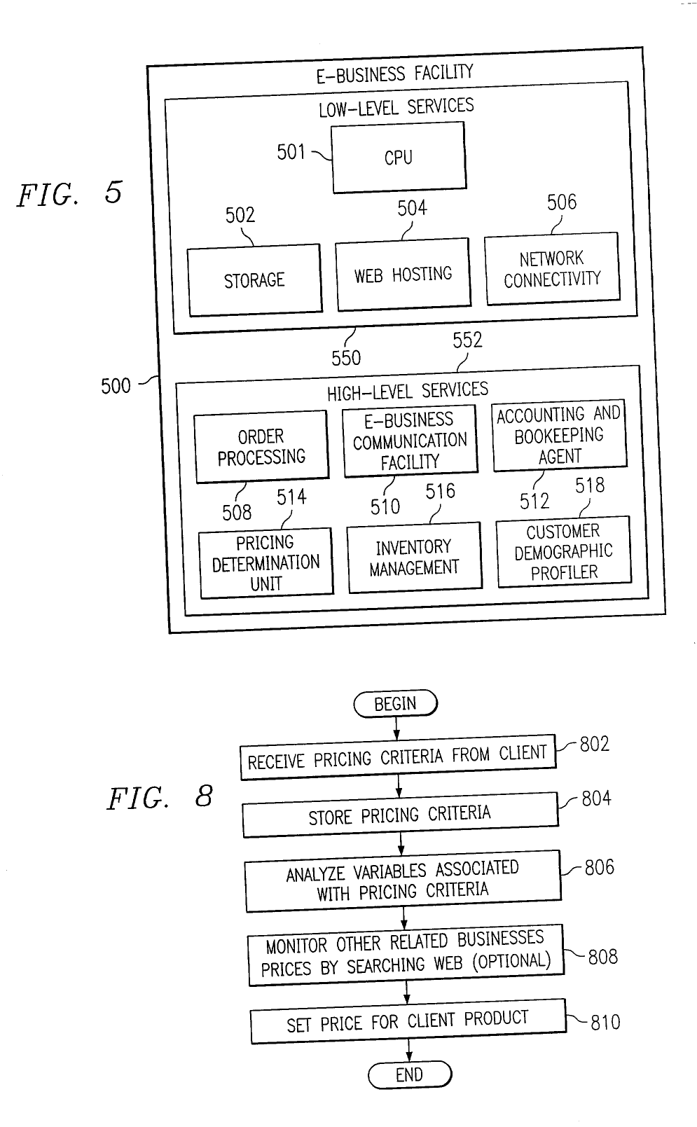

With reference now to FIG. 5, a block diagram illustrating an exemplary e-business facility, such as, for example, any of e-business facilities 406-410 in FIG. 4, is depicted in accordance with the present invention. E-business facility 500 includes low-level services 550 and high level services 552. Low-level services 550 includes storage 502, web hosting 504, network connectivity 506, and computation (CPU) 501. High-level services 552 includes order processing 508, e-business communication facility 510, accounting & bookkeeping agent 512, pricing determination unit 514, inventory management 516, and customer demographic profiler 518.

Storage 502 allows a business to store all or some of their data and software applications. Web hosting 504 provides the web site, web pages, and other services associated with a web site for the business. Network connectivity 506 provides the business with a connection to the Internet.

The high-level services 552 may be applications provided solely by the host, by the business client or a combination of both. Order processing 508 receives and processes customer orders on behalf of the business client. E-business communication facility 510 provides expedited communications between the business client and other business clients of the host. Accounting and Bookkeeping service 512 provides the accounting and bookkeeping services to the business client. Pricing determination unit 514 determines the appropriate price to charge for the various products and/or services offered by the business client. Inventory management 516 manages the inventory of the business client by, for example, reordering inventoried items when the number of items falls below a client determined threshold level. Customer demographic profiler 518 collects and interprets demographic information about the customers that purchase items from the business client.

The host thus enables business to gain efficiency in the digital aspects of their businesses by allowing the host to perform some or all of their digital business aspects. One reason for this gain in efficiency is due to the fact that the software used for each business client is compatible with that used for other clients. Furthermore, by managing the digital aspects of business for several clients, the efficiency of the business conducted between those business clients is improved. For example, if the inventory item needed by one business client is purchased from another business client of the host, then inventory management 516 may order new inventory using order processing 508 and e-business communications facility 510 to communicate with the other business client and order the necessary inventory item. The inventories of both business clients may be adjusted, the accounts credited or debited as appropriate and the shipping arranged for by the host without any action required of either business client. Another advantage is that, by outsourcing the operation of the digital components of its business, a client business may devote more of its resources to its core competencies. Other advantages are also provided as will be obvious to one of ordinary skill in the art upon becoming familiar with the present invention as described herein.

FIG. 5 is intended as an example, and not as an architectural limitation for the present invention.

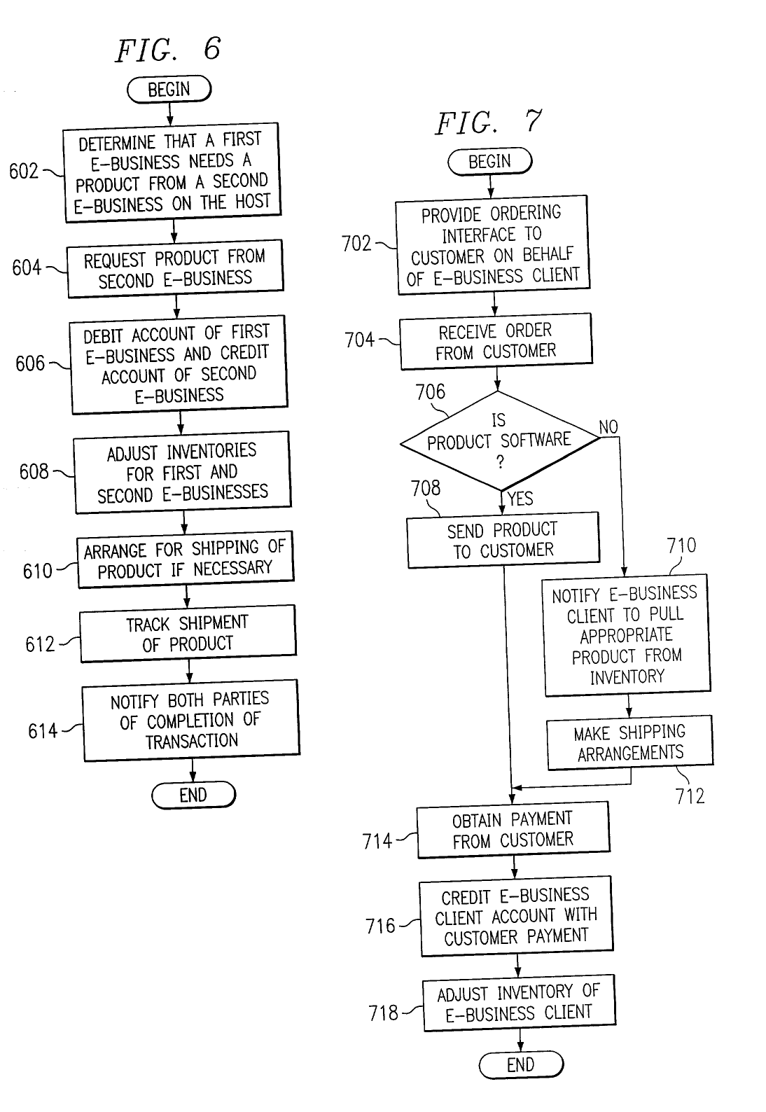

With reference now to FIG. 6, an exemplary process flow and program function for facilitating a business transaction between two business clients of a digital business host is depicted in accordance with the present invention. These processes may be implemented on, for example, host 404 in FIG. 4. To begin, the host under the control of the client determines that a first e-business client needs a product from a second e-business client of the host (step 602). The client may control the host by, for example, providing guidelines indicating how and when to make decisions on behalf of the client. This determination of e-business needs may be made, for example, by determining that the inventory level of a product has fallen below a threshold level determined by the client business or because needed to complete a sale of an item to a customer of the first e-business client. The host then requests the product in appropriate quantities from the second e-business (step 604). Again, the host requests the product subject to guidelines and restrictions placed upon the host by the client business. Thus, the client business may restrict the host to requesting and acquiring the product from a select number of providers. The account of the first e-business client is then debited appropriately and the account of the second e-business client is credited appropriately (step 606). The inventory accounting for both the first e-business client and the second e-business client are adjusted appropriately by the number of products purchased by the first e-business client.

The host then arranges for shipping of the product if necessary (step 610) and debits the account of the first e-business client appropriately to pay for the shipping charges. In some embodiments, the shipping company may also be a client of the digital business host and the transaction between the shipping company and the first e-business client handled completely by the digital business host. The host then tracks the shipping of the product if necessary (step 612) and notifies both parties of the completion of the transaction when the transaction has been completed (step 614). Thus, the host does not take charge of either the purchasing or selling the clients business, but merely provides services that carry out specific business-related tasks (e.g., inventory tracking) according to the instructions of, and under the supervision of, the client.

Thus, for example, an inventory tracking service provided by the host to client business A and configured by client business A according to its needs, observes a need for buying a particular part. Suppose that the inventory tracking has been set up (by the client business or a least with the client business's consent) to notify a specific purchasing service (possibly also provided by the host) of this need. The purchasing service, on being notified of the need, initiates a search for the part. The purchasing service has also been leased to, and configured by client business A, for example, to execute a particular strategy in selecting vendors and negotiating purchases. The purchasing module carries out its task, and notifies, for example, an accounting module to pay the purchaser. The accounting service has also been leased to, and configured by client business A. It contacts client business B to learn how to pay for the purchase and then carries out the transfer.

With reference now to FIG. 7, an exemplary process flow and program function for providing a customer ordering service to a e-business client via a digital business host is depicted in accordance with the present invention. To begin, the digital business host provides an ordering interface to a customer via the Internet or other network on behalf of the e-business client (step 702). The host then receives ordering information from the customer (step 704) and determines whether the ordered product is software (step 706). If the ordered product is not software, then the e-business client is notified to pull appropriate product from inventory and have available to ship to the customer (step 710). The host then makes shipping arrangements (step 712) and obtains payment from the customer (step 714). If the ordered product is software, such as, for example, computer application software, music, or movies, then the host retrieves the appropriate software from a on-line storage and sends the software to the customer over the network (step 708) after obtaining payment from the customer (step 714). After payment has been obtained from the customer, the host credits the e-business clients account with the customer payment (step 716) and adjusts the inventory of the e-business client (step 718).

As an alternative, rather than sending software electronically, a physical product containing the software may be shipped to the customer instead. For example, the software may be encoded on a digital versatile disc (DVD) and the DVD shipped to the customer.

With reference now to FIG. 8, an exemplary process flow and program function for setting prices for a e-business client's products is depicted in accordance with the present invention. To begin, the host receives pricing criteria from the client (step 802). For example, the criteria may state that the price should be set such that it is equal to the cost of the product to the e-business client plus a certain percentage of the cost or a plus a given dollar amount. Alternatively, the price may be set based on demand or such that no other companies product in the same category is priced lower than the product offered by the e-business client. Once the pricing criteria is received, the host stores the pricing criteria (step 804) and appropriate data is gathered and analyzed to determine the price (step 806). If the client has requested that the price be set based on the price other businesses charge for the same product, then the host may monitor related businesses prices by, for example, searching the web, (step 808). The host then sets the price for the client product (step 810). This price setting process may be a constant ongoing process to keep the client's product price in line with market conditions as well as maintain a profit for the client.

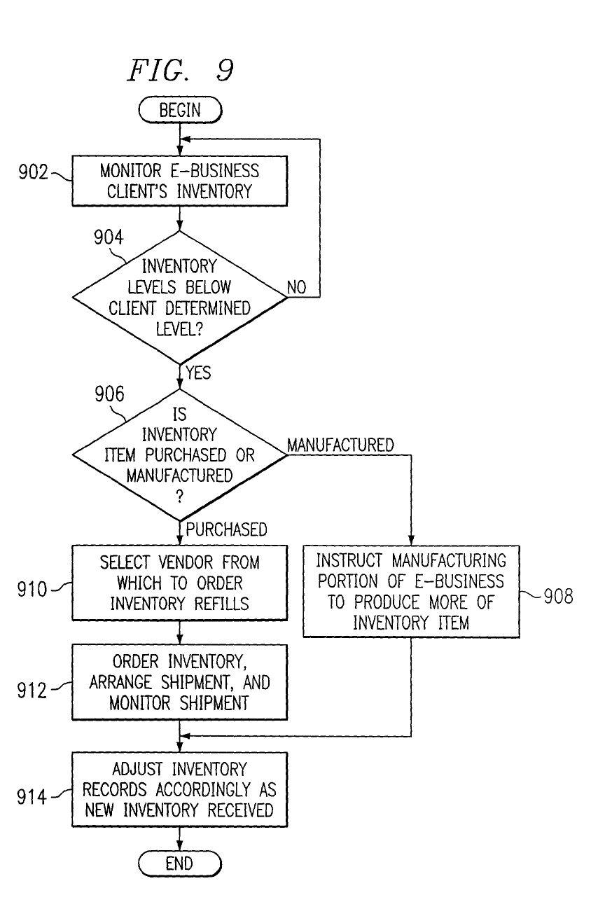

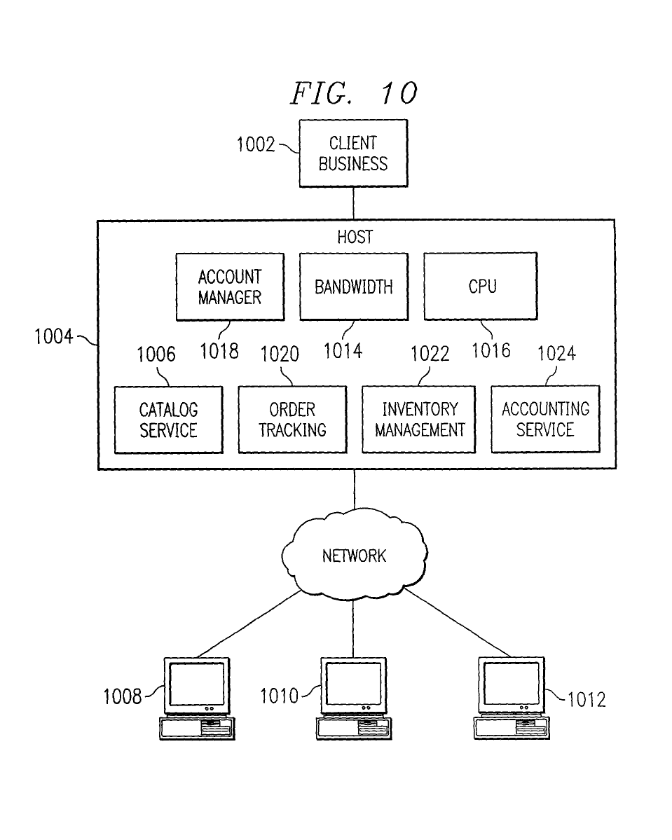

With reference now to FIG. 9, an exemplary process flow and program function for managing a client's inventory is depicted in accordance with the present invention. To begin, a host, such as host 404 in FIG. 4, monitors an e-business client's inventory (step 902) and determines whether inventory levels are below a client determined level (step 904). If the inventory levels have not fallen below a threshold level, then the host continues to monitor the client's inventory. If, however, the inventory has fallen below a threshold level, then the host determines whether the inventory item is a manufactured item or a purchased item for the client (step 906). If the item is manufactured by the client, then the host sends a message to the client or client's manufacturing section to produce more of the inventory item (step 908). If the inventory item is purchased by the client, then the host selects an appropriate vendor from which to order inventory refills (step 910). The host then orders the appropriate amount of the inventory item from the selected vendor, arranges shipment if necessary, and monitors the shipment (step 912). As the manufactured items or the purchased items are received, the host receives confirmation from the warehouse or other storage facility and adjusts the inventory records accordingly (step 914).

With reference now to FIG. 10, a block diagram providing an illustrative example of how the host would preferably support fast, automated reconfiguration of the services “leased” to a client business. Consider the following. Suppose the client business 1002 is a bookseller, and that it adds a new book to the catalog service 1006 it is leasing from the host 1004. Suppose that the book is in great demand, so that the addition of the book causes a sudden inrush of online shoppers 1008-1012 viewing its entry in the catalog 1006 and buying it.

The catalog service 1006 has been configured (by the client business 1002 or by the host 1004 with the client's consent 1002) to buy additional bandwidth 1014 and CPU 1016 when necessary, and to report to the account manager 1018 service any sudden increase of requests for information pertaining to any single product (especially a product newly added, or changed). The shoppers' 1008-1012 activity triggers both of these effects.

The account manager service 1018 has been configured (again, by the client 1002 or by the host 1004 with the client's 1002 consent) to respond to this notice as follows: it informs the order-tracking 1020, inventory management 1022, and accounting services 1024 leased by the client business 1002 that they should increase their capacity to process new orders.

Each of these three high-level services request additional services from the host 1004: the order-tracking 1020 requests additional bandwidth 1014, the inventory 1022 and accounting 1024 request for additional CPU 1016 to be reserved for it over the next few days. Under the terms of the overall agreement between the host 1004 and the client business 1002, and the particular configuration of the services by the client business 1002, the services' requests are processed by the host 1004, and the services are provided.

When the rush of orders is over, all four of the high-level services cancel the additional bandwidth 1014 and CPU 1016.

The host 1004 might bill the client business 1002 directly for the additional usage, might bill the clients 1002 account manager service 1018, or might bill the catalog 1006, etc., services, which would pass the charge on to the account manager 1018.

The gains in efficiency due to automation supplied by the present invention are obvious. Furthermore, because the setup of business relationships is automated, the hosting service permits a vastly greater degree of adaptability in client firms.

Another advantage of such hosting is that the client firms do not have to own and administer their own computational infrastructure for these components. The hosting service may maintain and upgrade the components it offers. It may offer new ones. This permits client digital businesses to focus on their core functionality.

A further advantage is that these hosted businesses have extremely fast communication paths with each other, so it may be possible for them to do business with each other more effectively than “outside” businesses could. This could give rise to “digital cities”, in which businesses cluster “near” each other for the same economic efficiencies that give rise to human cities.

A further advantage is that the hosting service will help ensure that hosted firms have greater interoperability capabilities than others. For example, the hosting service may make sure that all of the digital components it hosts conform to a common standard of interaction language, ontology, communication protocol, etc.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing electronic business functions for a business client, the method comprising:
providing, on a data processing system, first level services for a first business client;
providing, on the data processing system, second level services for the first business client; and
facilitating a transaction between the first business client and a third party business on behalf of the first business clients wherein the parameters defining the bounds in which the transaction takes place are determined by the first business client.

2. The method as recited in claim 1, wherein the data processing system is a plurality of networked data processing systems.

3. The method as recited in claim 1, wherein the first level services include at least one of providing storage, providing network connectivity, web hosting, and providing processing capability.

4. The method as recited in claim 1, wherein the second level services include at least one of providing inventory management services, providing accounting services, providing pricing services, and providing billing and collection services.

5. The method as recited in claim 1, wherein the third party business is a second business client.

6. The method as recited in claim 5, wherein facilitating transactions comprises:
identifying a purchasing need of the first business client;
identifying the second business client as a vendor for the purchasing need of the first business client;
facilitating payment; and
adjusting inventory records for, the first and second business client.

7. The method as recited in claim 6, wherein facilitating payment comprises:
transferring appropriate sums from an account belonging to the first business client to an account belonging to the second business client.

8. The method as recited in claim 1, wherein negotiations resulting in a service level agreement between a host of the first and second level services and the first business client for the providing of the first and second level services are automated.

9. The method as recited in claim 1, wherein the quantity of the first and second level services provided is adjusted by a host of the first and second level services based upon the fulfillment of criteria specified by the first business client.

10. The method as recited in claim 1, further comprising:
subcontracting the first level services from a secondary hosting service.

11. A computer program product in a computer readable media for use in a data processing system for providing electronic business functions for a business client, the computer program product comprising:
first instructions for providing, on a data processing system, first level services for a first business client;
second instructions for providing, on the data processing system, second level services for the first business client; and
third instructions for facilitating a transaction between the first business client and a third party business on behalf of the first business clients wherein the parameters defining the bounds in which the transaction takes place are determined by the first business client.

12. The computer program product as recited in claim 11, wherein the data processing system is a plurality of networked data processing systems.

13. The computer program product as recited in claim 11, wherein the first level services include at least one of providing storage, providing network connectivity, web hosting, and providing processing capability.

14. The computer program product as recited in claim 11, wherein the second level services include at least one of providing inventory management services, providing accounting services, providing pricing services, and providing billing and collection services.

15. The computer program product as recited in claim 11, wherein the third party business is a second business client.

16. The computer program product as recited in claim 15, wherein facilitating transactions comprises:
fourth instructions for identifying a purchasing need of the first business client;
fifth instructions for identifying the second business client as a vendor for the purchasing need of the first business client;
sixth instructions for facilitating payment; and
seventh instructions for adjusting inventory records for the first and second business client.

17. The computer program product as recited in claim 16, wherein facilitating payment comprises:
eighth instructions for transferring appropriate sums from an account belonging to the first business client to an account belonging to the second business client.

18. The computer program product as recited in claim 11, wherein negotiations resulting in a service level agreement between a host of the first and second level services and the first business client for the providing of the first and second level services are automated.

19. The computer program product as recited in claim 11, wherein the quantity of the first and second level services provided is adjusted by a host of the first and second level services based upon the fulfillment of criteria specified by the first business client.

20. The computer program product as recited in claim 11, further comprising:
fourth instructions for subcontracting the first level services from a secondary hosting service.

21. A system for providing electronic business functions for a business client, the system comprising:
a first service component which provides, on a data processing system, first level services for a first business client;
a second service component which provides, on the data processing system, second level services for the first business client; and
a transaction facilitating unit which facilitates a transaction between the first business client and a third party business on behalf of the first business clients wherein the parameters defining the bounds in which the transaction takes place are determined by the first business client.

22. The system as recited in claim 21, wherein the data processing system is a plurality of networked data processing systems.

23. The system as recited in claim 21, wherein the first level services include at least one of providing storage, providing network connectivity, web hosting, and providing processing capability.

24. The system as recited in claim 21, wherein the second level services include at least one of providing inventory management services, providing accounting services, providing pricing services, and providing billing and collection services.

25. The system as recited in claim 21, wherein the third party business is a second business client.

26. The system as recited in claim 25, wherein facilitating transactions comprises:
a need identifier which identifies a purchasing need of the first business client;
a vendor identifier which identifies the second business client as a vendor for the purchasing need of the first business client;
a payment unit which facilitates payment; and
an inventory unit which adjusts inventory records for the first and second business client.

27. The system as recited in claim 26, wherein the payment unit comprises:
a payment transfer unit which transfers appropriate sums from an account belonging to the first business client to an account belonging to the second business client.

28. The system as recited in claim 21, wherein negotiations resulting in a service level agreement between a host of the first and second level services and the first business client for the providing of the first and second level services are automated.

29. The system as recited in claim 21, wherein the quantity of the first and second level services provided is adjusted by a host of the first and second level services based upon the fulfillment of criteria specified by the first business client.

30. The system as recited in claim 21, further comprising:
a subcontracting unit which subcontracts the first level services from a secondary hosting service.

31. A method in a data processing system for facilitating business transactions, the method comprising:
hosting electronic business functions for a plurality of business clients;
identifying a need for a first business client based upon parameters received from the first business client;
determining a second business client, based on the parameters, capable of meeting the need of the first business client;
arranging for the second business client to perform a function fulfilling the first business client's need;
adjusting inventories, as necessary, of the first and the second business client; and
adjusting accounts of the first and the second business client to reflect payment for the item by the first business client to the second business client.

32. The method as recited in claim 31, wherein the function performed by the second business client is providing an item to the first business client.

33. The method as recited in claim 32, wherein the item has a tangible embodiment and is shipped from the second business client to the first business client.

34. The method as recited in claim 33, further comprising:
locating a shipping company;
arranging shipment of the item; and
arranging payment to the shipping company for the shipment.

35. The method as recited in claim 31, wherein the data processing system comprises a plurality of networked data processing systems.

36. A computer program product in a computer readable media for use in a data processing system for facilitating business transactions, the method comprising:
first instructions for hosting electronic business functions for a plurality of business clients;
second instructions for identifying a need for a first business client based upon parameters received from the first business client;
third instructions for determining a second business client, based on the parameters, capable of meeting the need of the first business client;
fourth instructions for arranging for the second business client to perform a function fulfilling the first business client's need;
fifth instructions for adjusting inventories of the first and the second business client; and
sixth instructions for adjusting accounts of the first and the second business client to reflect payment for the item by the first business client to the second business client.

37. A system in a data processing system for facilitating business transactions, the method comprising:
a hosting unit which hosts electronic business functions for a plurality of business clients;
a need identification unit which identifies a need for a first business client based upon parameters received from the first business client;
a vendor identification unit which determines a second business client, based on the parameters, capable of meeting the need of the first business client;
a transaction agent which arranges for the second business client to perform a function fulfilling the first business client's need;
an inventory monitoring unit which adjusts inventories of the first and the second business client; and
an accounting unit which adjusts accounts of the first and the second business client to reflect payment for the item by the first business client to the second business client.
